(19) United States
(12) Patent Application Publication
(10) Pub. No.: US 2021/0303291 A1
(43) Pub. Date: Sep. 30, 2021

(54) HANDS-FREE APPARATUS, DATA TRANSFER METHOD, AND COMPUTER-READABLE MEDIUM

(71) Applicant: Panasonic Intellectual Property Management Co., Ltd., Osaka (JP)

(72) Inventor: Mao TOHYAMA, Kanagawa Ken (JP)

(73) Assignee: Panasonic Intellectual Property Management Co., Ltd., Osaka (JP)

(21) Appl. No.: 17/205,616

(22) Filed: Mar. 18, 2021

(30) Foreign Application Priority Data
Mar. 27, 2020 (JP) 2020-057283

(51) Int. Cl. G06F 8/65; H04M 1/72; H04M 1/60; H04W 8/24

(52) U.S. Cl. CPC G06F 8/65; H04W 8/245; H04M 1/6041; H04M 1/72

(57) ABSTRACT

A hands-free apparatus includes a memory, and a hardware processor coupled to the memory. The hardware processor is configured to: perform a hands-free connection process of connecting to a mobile phone by using a hands-free communication protocol for performing a hands-free telephone conversation; perform a connection process with a mobile phone by using a data transfer protocol for transferring telephone data related to telephone, and a data transfer process of causing the telephone data to be transferred from the mobile phone; perform a software update process of the hands-free apparatus; and perform transfer control for causing the telephone data to be transferred. The hardware processor is configured to cause transfer of the telephone data not to be performed during the software update process.

### CROSS-REFERENCE TO RELATED APPLICATIONS

This application is based upon and claims the benefit of priority from Japanese Patent Application No. 2020-057283, filed on Mar. 27, 2020, the entire contents of which are incorporated herein by reference.

### FIELD

The present disclosure relates to a hands-free apparatus, a data transfer method, and a computer-readable medium.

### BACKGROUND

There has been known a configuration in which telephone data such as phonebook data and outgoing/incoming call history data is automatically transferred from a mobile phone to a hands-free apparatus by communication using a data transfer protocol such as a phone book access profile (PBAP). For example, there has been disclosed a technology in which a communication line is established between a mobile phone and a hands-free apparatus located within a near-field communication service area and telephone data is automatically transferred from the mobile phone to the hands-free apparatus (for example, see Japanese Patent Application Laid-open No. 2002-193046).

However, in the related art, when software update occurs in the hands-free apparatus, problems related to communication using a data transfer protocol may occur due to a transfer error of telephone data, connection disconnection, and the like.

### SUMMARY

A hands-free apparatus according to the present disclosure includes a memory, and a hardware processor coupled to the memory. The hardware processor is configured to: perform a hands-free connection process of connecting to a mobile phone by using a hands-free communication protocol for performing a hands-free telephone conversation; perform a connection process with a mobile phone by using a data transfer protocol for transferring telephone data related to telephone, and a data transfer process of causing the telephone data to be transferred from the mobile phone; perform a software update process of the hands-free apparatus; and perform transfer control for causing the telephone data to be transferred. The hardware processor is configured to cause transfer of the telephone data not to be performed during the software update process.

### BRIEF DESCRIPTION OF THE DRAWINGS

FIG. 1 is a schematic diagram of a hands-free system according to an embodiment;

FIG. 2 is a block diagram of the hands-free system according to the embodiment;

FIG. 3 is an example of a functional block diagram of a control unit according to the embodiment;

FIG. 4 is a flowchart of the flow of a transfer process of telephone data according to the embodiment;

FIG. 5 is a flowchart illustrating a processing flow when an incoming call has occurred while in the state of simultaneous connection according to the embodiment;

FIG. 6 is a flowchart illustrating a processing flow when an incoming call has occurred during the transfer of telephone data while in the state of simultaneous connection according to the embodiment;

FIG. 7 is a flowchart of the flow of a transfer process according to the embodiment;

FIG. 8 is a flowchart of the flow of a transfer process according to the embodiment;

FIG. 9 is a flowchart of the flow of a transfer process according to the embodiment;

FIG. 10 is a flowchart of the flow of a transfer process according to the embodiment;

FIG. 11 is a flowchart of the flow of data transfer timing control according to the embodiment;

FIG. 12 is a flowchart of the flow when data transfer is started with an operation of an operating unit by a user as a trigger according to the embodiment; and

FIG. 13 is a flowchart illustrating an example of the flow of transfer control during a software update process according to the embodiment.

### DETAILED DESCRIPTION

Hereinafter, embodiments of the present disclosure will be described in detail with reference to the drawings. Note that in each of the following embodiments, the same parts are denoted by the same reference numerals, and redundant description will be omitted.

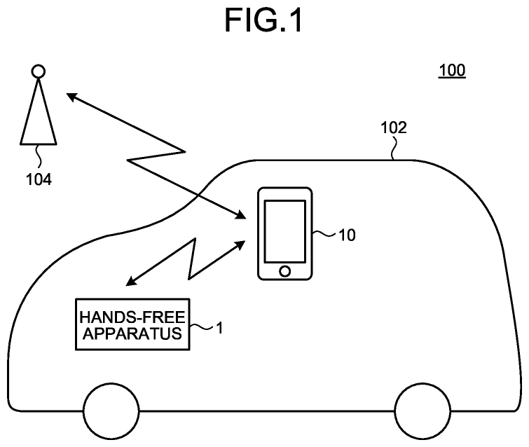

FIG. 1 is a schematic diagram illustrating an example of a hands-free system 100 of the present embodiment.

The hands-free system 100 includes a hands-free apparatus 1 and a mobile phone 10. The hands-free apparatus 1 and the mobile phone 10 are connected by wireless communication. The mobile phone 10 can communicate with a telephone such as another mobile phone 10 via a base station 104 via a telephone line.

The hands-free apparatus 1 is connected for communication to the mobile phone 10. The mobile phone 10 wirelessly communicates with the base station 104 via a mobile phone network. The mobile phone 10 is a smartphone, for example, and has a communication function based on the Bluetooth (registered trademark) system as near-field wireless communication means. Note that the mobile phone 10 may be a mobile phone of a type other than the smartphone as long as it has a communication function based on the Bluetooth system.

The hands-free apparatus 1 connects to the mobile phone network via the mobile phone 10. With this, a driver of a vehicle 102, for example, can make an outgoing call and receive an incoming call by operating the hands-free apparatus 1 even without operating the mobile phone 10. The hands-free apparatus 1 may be implemented as one function of an in-vehicle navigation device installed in the vehicle 102, for example.

In the present embodiment, a mode in which the hands-free apparatus 1 is installed in a vehicle 102 will be described as an example. Note that the present disclosure is not limited to the mode in which the hands-free apparatus 1 is installed in the vehicle 102.

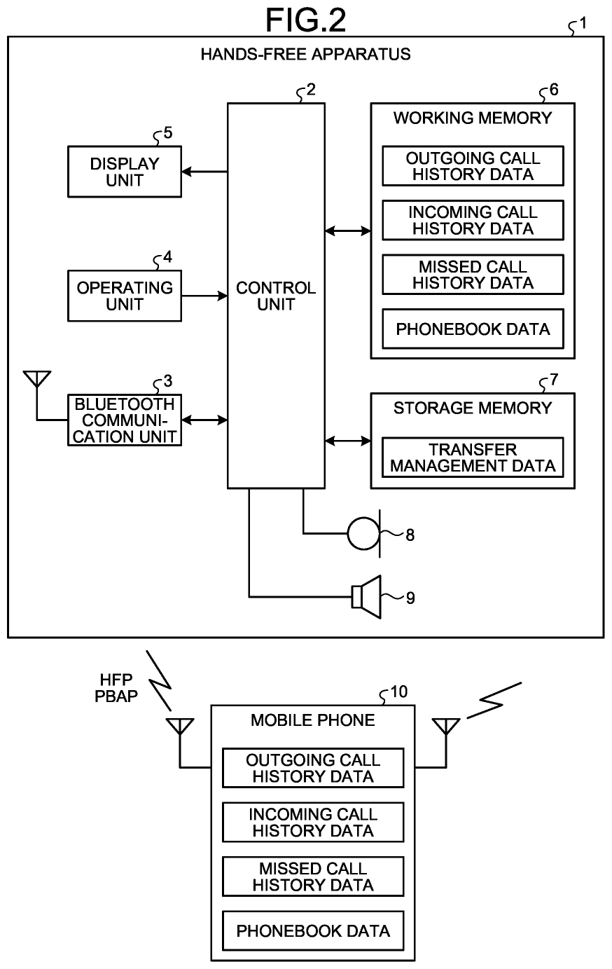

FIG. 2 is a block diagram of the hands-free system 100.

The mobile phone 10 establishes a mobile phone line with the base station 104 of the mobile phone network and performs outgoing call processing and incoming call processing.

The outgoing call processing is processing of making an outgoing call using an accepted telephone number as an outgoing call destination. For example, it is assumed that a user operates dial keys (“0” to “9” numeric keys) to input a telephone number of an outgoing call destination and then operates an outgoing call key. In such a case, the mobile phone 10 performs outgoing call processing of making an outgoing call using the accepted telephone number as an outgoing call destination. The outgoing call processing enables the mobile phone 10 to communicate with another mobile phone 10 of the outgoing call destination.

The incoming call processing is processing of receiving an incoming call from another mobile phone 10. For example, the mobile phone 10 receives an incoming call signal from the base station 104 in accordance with an outgoing call from another mobile phone 10. The mobile phone 10 receives the telephone number of the another mobile phone 10 of the outgoing call source as an incoming call telephone number. Then, the mobile phone 10 performs incoming call processing in response to the mobile phone 10 of the outgoing call source when the user operates an incoming call key. The incoming call processing enables the mobile phone 10 to communicate with the another mobile phone 10 of the outgoing call source.

The telephone communication state of the mobile phone 10 transitions due to the outgoing call processing, the incoming call processing, and the like.

The telephone communication state means a communication state between the mobile phone 10 and the another mobile phone 10 via a telephone line. Specifically, the telephone communication state is any one of an outgoing call state, an incoming call state, a telephone conversation state, and a standby state.

The outgoing call state is a state in which the mobile phone 10 is making an outgoing call using an accepted telephone number as an outgoing call destination. The incoming call state is a state in which the mobile phone 10 is receiving an incoming call from the another mobile phone 10. The telephone conversation state is a state in which the mobile phone 10 and the another mobile phone 10 are performing voice communication via the base station 104, that is, are holding a telephone conversation. The standby state is a state in which a communication state via the telephone line of the mobile phone 10 is neither the outgoing call state, the incoming call state, nor the telephone conversation state. In other words, the standby state is a state other than the telephone conversation state, which means a state of waiting for an incoming call or an outgoing call.

The mobile phone 10 transitions from any one telephone communication state of the outgoing call state, the incoming call state, the telephone conversation state, and the standby state to another one telephone communication state according to communication via the telephone line. The mobile phone 10 notifies the hands-free apparatus 1 of the telephone communication state by the HFP each time the telephone communication state transitions. Therefore, the hands-free apparatus 1 is configured to be able to specify the telephone communication state of the mobile phone 10.

The mobile phone 10 stores telephone data related to telephone. The telephone data includes at least one of outgoing call history data, incoming call history data, missed call history data, and phonebook data.

The outgoing call history data is data representing the outgoing call history of a telephone. Specifically, the outgoing call history data is one or more pieces of data in which correspondence between an outgoing call telephone number and an outgoing call date and time is set as one piece of data. The mobile phone 10 has a timepiece unit that counts a date and time. The mobile phone 10 sets correspondence between an outgoing call telephone number and an outgoing call date and time as one piece of data, and stores multiple pieces of outgoing call history data. The outgoing call telephone number is a telephone number accepted from the dial key in the outgoing call processing. The outgoing call date and time is a date and time measured by the timepiece unit during the outgoing call processing.

The incoming call history data is data representing an incoming call history of a telephone. Specifically, the incoming call history data is one or more pieces of data in which correspondence between an incoming call telephone number and an incoming call date and time is set as one piece of data. The mobile phone 10 sets correspondence between an incoming call telephone number and an incoming call date and time as one piece of data, and stores multiple pieces of incoming call history data. The incoming call telephone number is a telephone number accepted from the another mobile phone 10 via the base station 104 in the incoming call processing. The incoming call date and time is a date and time measured by the timepiece unit during the incoming call processing.

The missed call history data is data representing incoming call history when making no response to an incoming call from the another mobile phone 10. Specifically, the missed call history data is one or more pieces of data in which correspondence between an incoming call telephone number and an incoming call date and time is set as one piece of data. The mobile phone 10 sets correspondence between an incoming call telephone number received when making no response to an incoming call from the another mobile phone 10 and an incoming call date and time as one piece of data. Then, the mobile phone 10 stores the missed call history data which is one or more pieces of data.

The phonebook data is multiple pieces of data in which correspondence between telephone numbers and registered names is set as one piece of data. The mobile phone 10 correlates telephone numbers and registered names input by a user with each other, and stores, for example, about 500 correlated telephone numbers and registered names in a nonvolatile memory.

Note that the telephone data may also include all history data obtained by integrating the outgoing call history data, the incoming call history data, and the missed call history data. Hereinafter, when the outgoing call history data, the incoming call history data, the missed call history data, and all history data are collectively described, they may be simply referred to as history data. Furthermore, the history data may not include all history data.

The outgoing call history data, the incoming call history data, and the missed call history data may further include registered names.

The mobile phone 10 determines whether the telephone number of an incoming call telephone number received from the base station 104 has been registered in the phonebook data. When the telephone number has been registered, the mobile phone 10 stores a registered name corresponding to the telephone number as incoming call history data in correlation with the telephone number and an incoming call date and time. It is sufficient if the mobile phone 10 stores a registered name as missed call history data in correlation with an incoming call telephone number and an incoming call date and time, similarly to when making no response to an incoming call from the another mobile phone 10. Furthermore, the mobile phone 10 determines whether the telephone number of a transmitted incoming call telephone number has been registered in the phonebook data. When the telephone number has been registered, the mobile phone 10 stores a registered name corresponding to the telephone number as outgoing call history data in correlation with the telephone number and an outgoing call date and time.

When a display request by a user's operation and the like is accepted, the mobile phone 10 displays the phonebook data. The mobile phone 10 accepts the selection of one of the telephone numbers included in the phonebook data, and accepts an outgoing call instruction. The mobile phone 10 performs outgoing call processing with the selected telephone number as an outgoing call destination. Therefore, the user can perform the outgoing call processing to be performed without error by a simple operation even without inputting all numeric keys corresponding to numbers constituting the telephone number one by one.

The mobile phone 10 can store, for example, the latest 20 pieces of each of the outgoing call history data, the incoming call history data, and the missed call history data. The mobile phone 10 automatically deletes the oldest data each time the outgoing call processing, the incoming call processing, and the missed call processing are performed, thereby updating these data. Note that the number of these data stored in the mobile phone 10 is not limited to 20.

In the present embodiment, the mobile phone 10 has a near-field wireless communication function. In the present embodiment, the mobile phone 10 performs near-field wireless communication corresponding to Bluetooth (registered trademark) as a wireless communication standard. The mobile phone 10 connects to and communicates with the hands-free apparatus 1 by using a profile such as a hands-free profile and a phone book access profile. The hands-free profile will be hereinafter referred to as a hands free profile (HFP) for description. The phone book access profile will be hereinafter referred to as a phone book access profile (PBAP) for description.

The HFP is a hands-free communication protocol for performing hands-free communication and is a profile defined by a wireless communication standard. The PBAP is a data transfer protocol for transferring telephone data and is a profile defined by a wireless communication standard. These profiles indicate communication protocols defined for each function.

The PBAP is an example of a data transfer protocol for performing data transfer and is a profile defined by a Bluetooth standard. The PBAP is a profile capable of automatically transferring telephone data from the mobile phone 10 to the hands-free apparatus 1 without the user operating the mobile phone 10 after connection using the PBAP is made. That is, the mobile phone 10 is configured to be able to automatically transfer the telephone data to the hands-free apparatus 1.

For example, the mobile phone 10 connects the PBAP immediately after establishing a communication line with the hands-free apparatus 1, and automatically transfers telephone data stored at that time to the hands-free apparatus 1. With this, when the mobile phone 10 is present within the Bluetooth communication service area of the hands-free apparatus 1, the mobile phone 10 automatically transfers the telephone data (the phonebook data, the outgoing call history data, the incoming call history data, and the missed call history data) to the hands-free apparatus 1.

Next, the hands-free apparatus 1 will be described.

The hands-free apparatus 1 includes a control unit 2, a Bluetooth communication unit 3, an operating unit 4, a display unit 5, a working memory 6, a storage memory 7, a microphone 8, and a speaker 9.

The control unit 2 and the Bluetooth communication unit 3, the operating unit 4, the display unit 5, the working memory 6, the storage memory 7, the microphone 8, and the speaker 9 are connected so as to exchange data or signals.

The control unit 2 controls an entire operation such as a communication operation and a data management operation of the hands-free apparatus 1. Details of the control unit 2 will be described below.

The Bluetooth communication unit 3 is a wireless communication device that performs near-field wireless communication. In the present embodiment, the Bluetooth communication unit 3 performs near-field wireless communication corresponding to Bluetooth as a wireless communication standard. In the present embodiment, the Bluetooth communication unit 3 establishes a wireless communication line with the mobile phone 10 present within the Bluetooth communication service area, and performs communication pursuant to Bluetooth communication standards.

The Bluetooth communication unit 3 connects to and communicates with the mobile phone 10 by using the HFP, which is a hands-free communication protocol for performing hands-free communication and the PBAP, which is a data transfer protocol for transferring telephone data.

Furthermore, the Bluetooth communication unit 3 is configured to be able to perform multi-profile connection.

Therefore, the Bluetooth communication unit 3 can be simultaneously connected to the mobile phone 10 by using both the HFP and the PBAP.

The multi-profile connection may be referred to as simultaneous connection. In Bluetooth, maximum seven slave communication devices can be simultaneously connected to one master communication device by time division multiplexing. That is, a communication channel can perform communication by seven independent time division channels. In such a case, the simultaneous connection uses two of the seven communication channels, uses one of the two communication channels in the HFP, and uses the other one thereof in the PBAP. Furthermore, a logical channel of one communication channel may be shared with the HFP and the PBAP and simultaneously operated as in packet communication.

The operating unit 4 accepts user's input. The operating unit 4 includes touch keys formed on the display unit 5, for example, accepts an operating signal representing user's operation content, and outputs the operating signal to the control unit 2.

The display unit 5 displays a display screen on the basis of a display signal accepted from the control unit 2. For example, the display unit 5 displays a display screen for accepting the input of a telephone number by the user. The display screen is, for example, a screen in which dial keys corresponding to “0” to “9” are arranged.

The working memory 6 stores various data. In the present embodiment, the working memory 6 stores the phonebook data, the outgoing call history data, the incoming call history data, and the missed call history data which are telephone data automatically transferred from the mobile phone 10. The working memory 6 can store, for example, five pieces of each of the outgoing call history data, the incoming call history data, and the missed call history data. Note that the number of data storable in the working memory 6 is not limited to 5. The working memory 6 is, for example, a volatile memory.

The storage memory 7 stores various data. The storage memory 7 is composed of, for example, a nonvolatile memory.

The microphone 8 accepts the input of voices emitted by the user when performing a hands-free telephone conversation using the mobile phone 10. The speaker 9 outputs accepted voices of a telephone conversation destination when performing the hands-free telephone conversation using the mobile phone 10.

The hands-free apparatus 1 may further include various configurations required for a navigation operation. For example, the hands-free apparatus 1 may also include a global positioning system (GPS), a route search unit, a map data reading unit, a vehicle information and communication system (VICS; registered trademark) information reception unit, a voice recognition unit, and the like.

The GPS is a system that detects a current position of its own vehicle. The route search unit is a system that searches for a route from the current position to a destination. The map data reading unit is a system that reads map data from a recording medium. The VICS information reception unit is a system that receives VICS information distributed from a VICS center. The voice recognition unit is a system that voice-recognizes voices emitted by the user.

The hands-free apparatus 1 is configured to supply power and stop the supply of the power in conjunction with the on and off of an ACC switch (accessory power supply) of the vehicle 102, for example. For example, it is assumed that the ACC switch is switched from on to off in accordance with a user's operation. In such a case, when the supply of the power to the hands-free apparatus 1 is stopped. When the supply of the power is stopped, the outgoing call history data, the incoming call history data, the missed call history data, and the phonebook data stored in the working memory 6 are deleted. On the other hand, various data such as transfer management data stored in the storage memory 7 are not deleted and are stored as is even after the supply of the power is stopped.

Next, details of the control unit 2 will be described.

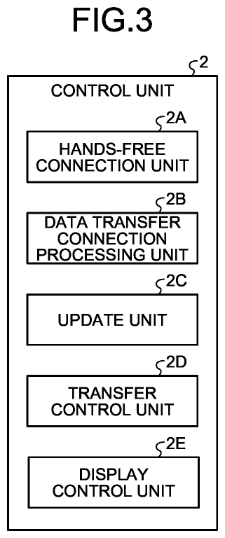

FIG. 3 is an example of a functional block diagram of the control unit 2. The control unit 2 includes a hands-free connection unit 2A, a data transfer connection processing unit 2B, an update unit 2C, a transfer control unit 2D, and a display control unit 2E.

The hands-free connection unit 2A, the data transfer connection processing unit 2B, the update unit 2C, the transfer control unit 2D, and the display control unit 2E are implemented by, for example, one or more processors. For example, each of the elements described above may be implemented by causing a processor such as a central processing unit (CPU) to execute a computer program, that is, software. Each of the elements described above may also be implemented by a processor such as a dedicated integrated circuit (IC), that is, hardware. Each of the elements described above may also be implemented by using software and hardware in combination. When the processors are used, each of the processors may implement one of the elements, or two or more of the elements.

The processor may implement each of the elements described above by reading and executing a computer program stored in the storage memory 7. Note that instead of storing the computer program in the storage memory 7, the computer program may be directly incorporated in a circuit of the processor. In such a case, the processor implements each of the elements described above by reading and executing the computer program incorporated in the circuit.

The hands-free connection unit 2A performs a hands-free connection process of wirelessly connecting to the mobile phone 10 by using the HFP. The hands-free connection process is a process of establishing a wireless communication connection with the mobile phone 10 by using the HFP. That is, the hands-free connection unit 2A establishes the connection of the HFP between the hands-free apparatus 1 and the mobile phone 10.

When the HFP connection is established, the hands-free apparatus 1 is in a state of being able to perform a hands-free telephone conversation via the mobile phone 10. Specifically, the hands-free connection unit 2A transmits the voice accepted from the microphone 8 to the mobile phone 10 via the Bluetooth communication unit 3. The mobile phone 10 transmits the voice accepted from the hands-free apparatus 1 to a mobile phone 10 having an outgoing call destination telephone number via the base station 104. Furthermore, the hands-free connection unit 2A receives voice accepted by the mobile phone 10 from the another mobile phone 10 via the Bluetooth communication unit 3, and outputs the received voice to the speaker 9. Therefore, the hands-free apparatus 1 can perform the hands-free telephone conversation. Note that in the present embodiment, the wireless communication connection using the HFP may be referred to as the connection of the HFP or an HFP connection for description.

The data transfer connection processing unit 2B performs a wireless communication connection process with the mobile phone 10 using the PBAP, and a data transfer process of causing the telephone data to be transferred from the mobile phone 10. The data transfer connection processing unit 2B establishes a wireless communication connection using the PBAP with the mobile phone 10 via the Bluetooth communication unit 3. The wireless communication connection using the PBAP is established, so that the telephone data is automatically transferred from the mobile phone 10 to the hands-free apparatus 1. The automatic transfer means that data is transferred between the hands-free apparatus 1 and the mobile phone 10 without any user's operation. Hereinafter, the automatic transfer of the telephone data from the hands-free apparatus 1 to the mobile phone 10 may be referred to as acquisition of the telephone data by the hands-free apparatus 1 or transfer of the telephone data for description. Furthermore, in the present embodiment, the wireless communication connection using the PBAP may be referred to as a connection of the PBAP or a PBAP connection for description.

When the connection of the PBAP is established, the data transfer connection processing unit 2B sequentially transmits each transfer request for the history data such as the outgoing call history data, the incoming call history data, and the missed call history data to the mobile phone 10. The data transfer connection processing unit 2B transmits the transfer request to the mobile phone 10 under the control of the transfer control unit 2D to be described below.

The mobile phone 10 transfers the history data corresponding to the transfer request, which is accepted from the hands-free apparatus 1, to a mobile phone 10. Furthermore, the data transfer connection processing unit 2B transmits a transfer request for the phonebook data to the mobile phone 10. The mobile phone 10 transfers the phonebook data to a mobile phone 10 according to the transfer request accepted from the hands-free apparatus 1. By these processes, the telephone data is automatically transferred from the mobile phone 10 to the hands-free apparatus 1.

Furthermore, the data transfer connection processing unit 2B transmits a transfer stop request to the mobile phone 10 under the control of the transfer control unit 2D to be described below. The transfer stop request is a signal for requesting the stop or interruption of the automatic transfer of the telephone data. The mobile phone 10 having accepted the transfer stop request stops or interrupts the transfer of the telephone data, which is being transferred, to the hands-free apparatus 1.

The update unit 2C performs a software update process of the hands-free apparatus 1. The software of the hands-free apparatus 1 is software that has been installed in the hands-free apparatus 1 or is to be newly installed in the hands-free apparatus 1. For example, the software is an operating system (OS) of the hands-free apparatus 1, various application programs running on the OS, and the like. In the present embodiment, a case where the software update process is an update process of updating the OS of the hands-free apparatus 1 will be described as an example.

The update unit 2C determines whether to update software. For example, when an update instruction is accepted by operation input of the operating unit 4 by a user, the update unit 2C determines to update software. For example, when it is determined to update software, for example, the update unit 2C acquires software to be updated from an external device, and performs an update process of the software. The external device is, for example, a storage medium storing the software to be updated, an external device connected via a network and the like. The user who inputs the operation of the update instruction is a user of the mobile phone 10, a driver of the vehicle 102, a maintenance person of the vehicle 102, a seller of the vehicle 102, and the like; however, the present disclosure is not limited thereto. Furthermore, a method of acquiring the software to be updated is not limited.

Furthermore, the update of the software by the update unit 2C is not limited to when the update instruction is accepted by the operation input. For example, it is assumed that a universal serial bus (USB) memory storing the software to be updated is connected to a USB terminal (not illustrated) provided in the hands-free apparatus 1. By determining such a connection, the update unit 2C may determine to update the software. Then, it is sufficient if the update unit 2C acquires the software from the USB memory and performs the update process of the software.

Furthermore, it is assumed that a dedicated device storing the OS is communicably connected to the hands-free apparatus 1. By determining such a connection, the update unit 2C may determine to update the software. Furthermore, when the dedicated device is communicably connected to the hands-free apparatus 1, it is sufficient if the update unit 2C acquires the software from the dedicated device and performs the update process of the software.

The transfer control unit 2D performs transfer control related to the transfer of the telephone data. The transfer control is control for causing the telephone data to be transferred from the mobile phone 10. The transfer control unit 2D performs transfer control such as causing the transfer of the telephone data to be continued and disabling the transfer.

The causing the transfer to be continued means to cause the transfer of the telephone data being transferred to be continued. The disabling the transfer means at least one of stop of the transfer of the telephone data being transferred and interruption of the transfer of the telephone data being transferred.

Meanwhile, for example, in a case where an update process of the OS occurs, when the transfer function itself is forcibly terminated by forcibly terminating the application program at the level of the OS, the basic input/output system (BIOS), and the like, when no transfer request is accepted as a result of the forcible termination, and the like, the transfer of the telephone data by the transfer control unit 2D is not performed. In such a case, the transfer control unit 2D does not perform the transfer of the telephone data.

The transfer control unit 2D performs the transfer control by controlling the transmission timing of the transfer request, the type of the transfer request to be transmitted, and transmission and the like of the transfer stop request, which are transmitted from the data transfer connection processing unit 2B to the mobile phone 10. The type of the transfer request to be transmitted is the type of the telephone data requested to be transferred. The type of the telephone data means each of the outgoing call history data, the incoming call history data, the missed call history data, all history data, and the phonebook data.

The transfer control unit 2D controls the data transfer connection processing unit 2B to transmit the transfer request to the mobile phone 10, thereby performing the transfer control for causing the telephone data to be transferred. Furthermore, the transfer control unit 2D controls the data transfer connection processing unit 2B to transmit the transfer stop request to the mobile phone 10, thereby performing the transfer control for disabling the transfer of the telephone data.

By the above control, the transfer control unit 2D performs the transfer control for controlling the transfer of the telephone data by the data transfer connection processing unit 2B. By the transfer control by the transfer control unit 2D, the transfer of the telephone data from the mobile phone 10 is disabled, or the transfer of the telephone data is started or continued in the hands-free apparatus 1.

In the present embodiment, the transfer control unit 2D performs transfer control corresponding to the software update process by the update unit 2C. The transfer control by the transfer control unit 2D will be described in detail below.

The display control unit 2E controls the display unit 5 to display a display screen by outputting a display instruction to the display unit 5.

For example, it is assumed that a display request for the outgoing call history data is accepted from the operating unit 4 by the operation of the operating unit 4 by the user. In such a case, the display control unit 2E outputs a display instruction of the outgoing call history data stored in the working memory 6 to the operating unit 4. By accepting the display instruction, the outgoing call history data is displayed on the display unit 5. For example, maximum five pieces of outgoing call history data is displayed on the display unit 5.

Furthermore, for example, it is assumed that a display request for the incoming call history data is accepted from the operating unit 4 by the operation of the operating unit 4 by the user. In such a case, the display control unit 2E outputs a display instruction of the incoming call history data stored in the working memory 6 to the operating unit 4. By accepting the display instruction, the incoming call history data is displayed on the display unit 5. For example, maximum five pieces of incoming call history data is displayed on the display unit 5.

Furthermore, for example, it is assumed that a display request for the missed call history data is accepted from the operating unit 4 by the operation of the operating unit 4 by the user. In such a case, the display control unit 2E outputs a display instruction of the missed call history data stored in the working memory 6 to the operating unit 4. By accepting the display instruction, the missed call history data is displayed on the display unit 5. For example, maximum five pieces of missed call history data is displayed on the display unit 5.

Furthermore, for example, it is assumed that a display request for the phonebook data is accepted from the operating unit 4 by the operation of the operating unit 4 by the user. In such a case, the display control unit 2E outputs a display instruction of the phonebook data stored in the working memory 6 to the operating unit 4. By accepting the display instruction, the phonebook data is displayed on the display unit 5.

Next, the operation of the hands-free apparatus 1 of the present embodiment will be described. The present embodiment will be described on the assumption that the mobile phone 10 stores 20 pieces (maximum storable number) of outgoing call history data and incoming call history data, and that the mobile phone 10 in this state is carried by the user or the like and reaches the inside of the vehicle 102 to enter the Bluetooth communication service area of the hands-free apparatus 1.

Note that in the present embodiment, it is assumed that the mobile phone 10 to be a Bluetooth communication counterpart has been registered in advance in the hands-free apparatus 1. For example, by inputting a 4-digit password for each mobile phone 10 at the time of initial communication, the hands-free apparatus 1 generates a link key for each mobile phone 10. Then, each of the mobile phones 10 and the hands-free apparatus 1 stores the link key. The hands-free apparatus 1 selects a mobile phone 10 to be connected by authenticating the link key at the time of initial connection. That is, a mobile phone 10 not registered in the hands-free apparatus 1 is not connected by the HFP and the PBAP.

In the present embodiment, it is assumed that a plurality of mobile phones 10 to be connected for communication have been registered in advance in the hands-free apparatus 1. Furthermore, in the hands-free apparatus 1, a priority is set in advance for each of the mobile phones 10. It is sufficient if the priority is set in advance by the operation of the operating unit 4 by the user, for example.

First, the flow of the transfer of the telephone data from the mobile phone 10 to the hands-free apparatus 1 will be described.

In the following, connection by the wireless communication using the HFP may be simply referred to as the connection of the HFP or HFP connection for description. Similarly, connection by the wireless communication using the HF may be simply referred to as the connection of the HF or HFP connection for description.

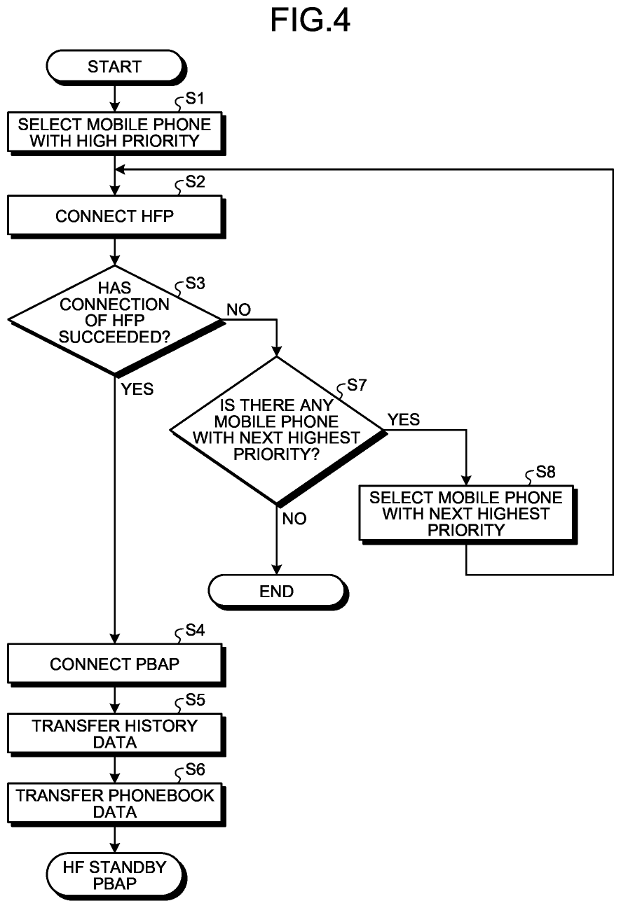

FIG. 4 is a flowchart illustrating an example of the flow of the transfer process of the telephone data that is performed in the hands-free apparatus 1.

The hands-free connection unit 2A selects a mobile phone 10 with a high priority as a target of connection of the HFP (step S1). The hands-free connection unit 2A performs the HFP connection to the selected mobile phone 10 (step S2). By the process of step S2, connection of the HFP is established between the hands-free apparatus 1 and the mobile phone 10. The establishment of the connection of the HFP may be referred to as establishment of the connection of the HFP or HFP connection establishment for description.

The hands-free connection unit 2A determines whether the connection of the HFP has succeeded (step S3). When the hands-free connection unit 2A determines that the connection of the HFP has succeeded (Yes at step S3), the present routine proceeds to step S4.

At step S4, the data transfer connection processing unit 2B connects the PBAP to the mobile phone 10 determined to have succeeded in the connection of the HFP at step S3 (step S4). At step S4, the data transfer connection processing unit 2B performs an initial connection process. The initial connection process is a connection process for establishing a communication link used for data transfer using the PBAP.

Next, the transfer control unit 2D performs a data transfer process of the history data (step S5). The transfer control unit 2D controls the data transfer connection processing unit 2B to sequentially transmit a transfer request for the history data to the mobile phone 10 by the PBAP. In response to the transfer request, the mobile phone 10 transmits the history data to the hands-free apparatus 1 by using the PBAP. By these processes, the history data is automatically transferred from the mobile phone 10 to the hands-free apparatus 1.

When the transfer process of the history data ends, the transfer control unit 2D starts a transfer process of the phonebook data (step S6), and performs the transfer process of the phonebook data. The transfer control unit 2D controls the data transfer connection processing unit 2B to transmit a transfer request for the phonebook data to the mobile phone 10 by the PBAP. In response to the transfer request, the mobile phone 10 transmits the phonebook data to the hands-free apparatus 1 by using the PBAP. By these processes, the phonebook data is automatically transferred from the mobile phone 10 to the hands-free apparatus 1.

On the other hand, when the hands-free connection unit 2A determines at step S3 that the connection of the HFP has not succeeded (No at step S3), the present routine proceeds to step S7.

At step S7, the hands-free connection unit 2A determines whether there is any mobile phone 10 with the next highest priority (step S7). When the hands-free connection unit 2A determines that there is any mobile phone 10 with the next highest priority (Yes at step S7), the present routine proceeds to step S8. When a negative determination is made at step S7 (No at step S7), the present routine ends.

At step S8, the hands-free connection unit 2A selects the mobile phone 10 with the next highest priority as a target of connection of the HFP (step S8). Then, the present routine returns to step S2.

It is assumed that the telephone communication state of the mobile phone 10 is in a standby state. In such a case, when the connection of the HFP is succeeded at step S2, the hands-free apparatus 1 can perform telephone conversation processing and outgoing call processing. Specifically, the hands-free apparatus 1 can perform the telephone conversation processing of accepting an incoming call to the mobile phone 10 through the operating unit 4 and performs a telephone conversation, and the outgoing call processing of making an outgoing call to a mobile phone by an operation from the operating unit 4. The state of the hands-free apparatus 1 may be hereinafter referred to as a hands-free standby state for description.

Furthermore, by the process of step S4, the PBAP connection is established between the hands-free apparatus 1 and the mobile phone 10. Furthermore, by the processes of step S2 to step S4, the hands-free apparatus 1 is in a state of being simultaneously connected.

Therefore, when the mobile phone 10 approaches the hands-free apparatus 1 and a Bluetooth-based wireless connection is made, PBAP-based data transfer is performed and the HFP is in a simultaneous connection state, so that the hands-free standby state of the hands-free apparatus 1 is maintained.

Furthermore, the hands-free apparatus 1 first makes a connection of only the HFP with the mobile phone 10 present within the Bluetooth communication service area, enters the hands-free standby state, and then performs an initial connection process of the PBAP.

Therefore, even when the initial connection of the HFP and the initial connection of the PBAP are simultaneously performed, the hands-free apparatus 1 can reduce load due to the simultaneous process and suppress the complication of software due to the simultaneous process. Furthermore, the hands-free apparatus 1 can suppress delay in the completion of the HFP connection by the simultaneous process. Therefore, the hands-free apparatus 1 can stably and reliably perform the simultaneous connection.

Furthermore, the hands-free apparatus 1 can shorten the connection time until the connection of the HFP is completed. Therefore, when the user brings the mobile phone 10 into the vehicle, outgoing call processing and incoming call processing by HFP-based hands-free standby become possible at an early stage.

Furthermore, when the HFP and the PBAP are in the state of simultaneous connection between the hands-free apparatus 1 and the mobile phone 10, there is a case where the mobile phone 10 detects an incoming call. In such a case, the hands-free apparatus 1 performs the following processing.

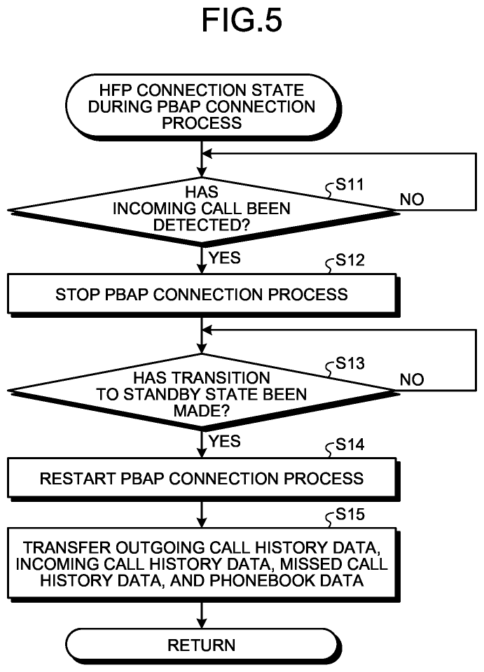

FIG. 5 is a flowchart illustrating an example of a processing flow when an incoming call has occurred in the mobile phone 10 while in the state of simultaneous connection. The state of simultaneous connection is the state of step S4 of FIG. 4.

The transfer control unit 2D determines whether the mobile phone 10 has detected an incoming call when the HFP is connected and the PBAP is being connected (corresponding to the process of step S4) (step S11). When it is determined that the mobile phone 10 has detected the incoming call (Yes at step S11), the present routine proceeds to step S12.

At step S12, the transfer control unit 2D stops the PBAP connection process by the data transfer connection processing unit 2B (step S12).

Next, the transfer control unit 2D determines whether an incoming call state due to the incoming call detected at step S11 or a telephone conversation state due to the incoming call has ended and has transitioned to a standby state (step S13). The transfer control unit 2D performs the determination of step S13 by determining whether the telephone communication state notified by the HFP from the mobile phone 10 indicates a transition from the outgoing call state or the telephone conversation state to the standby state.

When it is determined that transition to the standby state has been made (Yes at step S13), the present routine proceeds to step S14. The pattern, in which it is determined at step S13 that transition to the standby state has been made, includes the following case, for example. For example, this is a case where the hands-free apparatus 1 has rejected the incoming call. Furthermore, for example, this is a case where a mobile phone 10 of an outgoing call counterpart side has cancelled an outgoing call. Furthermore, this is a case where a telephone conversation has ended between a mobile phone 10 and a mobile phone 10.

At step S14, the transfer control unit 2D causes the PBAP connection process to be restarted from the beginning (step S14), and causes the telephone data to be transferred from the mobile phone 10 again (step S15).

With this, the following effects are obtained even when the mobile phone 10 receives an incoming call while the PBAP connection process is in progress. That is, the transfer control unit 2D restarts the PBAP connection process from the beginning after the incoming call state or the telephone conversation state due to the incoming call ends and transitions to the standby state. Therefore, it is possible to appropriately achieve the outgoing call history data, the incoming call history data, the missed call history data, and the phonebook data from the mobile phone 10. Therefore, it is possible to maintain consistency between these telephone data and telephone data stored in the mobile phone 10.

Note that in S14, a mode in which the PBAP connection is restarted from the beginning when transition from the incoming call state to the standby state is made has been described. This is due to the following reasons.

Specifically, at the time when the incoming call state has been detected, new incoming call history data is generated in the mobile phone 10. At the time when the incoming call state has been detected, it is also possible to start the initial connection process of the PBAP. However, when an incoming call state is still continued at the time when the initial connection process is performed and data transfer is started, it is unclear whether the incoming call is a missed call or an answered incoming call. Therefore, even though data related to the incoming call is received in such a state, the hands-free apparatus 1 is not able to determine whether the incoming call is a missed call or an answered incoming call. In this regard, the transfer control unit 2D may also restart the initial connection process of the PBAP and the data transfer from the beginning at the timing at which the incoming call state has been transitioned to a different state.

Note that the telephone communication state of the mobile phone 10 eventually transitions to the standby state. Therefore, when the transition to the standby state is determined at step S13, the present routine proceeds to step S14. Note that when the transition from the incoming call state to the telephone conversation state is determined at step S3, the present routine may proceed to step S14.

On the other hand, while the HFP and the PBAP are in the state of simultaneous connection between the hands-free apparatus 1 and the mobile phone 10 and the telephone data is being transferred, there is a case where the mobile phone 10 detects an incoming call. In such a case, the hands-free apparatus 1 performs the following processing.

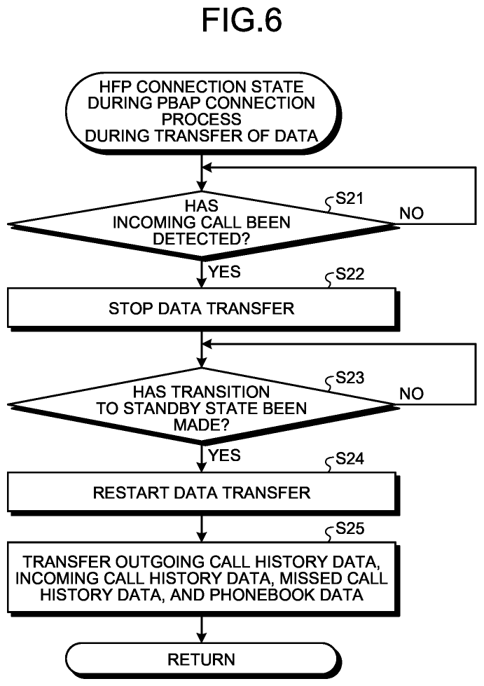

FIG. 6 is a flowchart illustrating an example of a processing flow when an incoming call has occurred in the mobile phone 10 during the state of simultaneous connection and the transfer of the telephone data. The “during the state of simultaneous connection and the transfer of the telephone data” corresponds to any one state of step S5 and step S6 of FIG. 4 and step S15 of FIG. 5.

The transfer control unit 2D determines whether the mobile phone 10 has detected an incoming call during the transfer of the telephone data (step S21). When it is determined that the mobile phone 10 has detected the incoming call (Yes at step S21), the present routine proceeds to step S22.

At step S22, the transfer control unit 2D stops the transfer of the telephone data by the data transfer connection processing unit 2B (step S22).

Next, the transfer control unit 2D determines whether an incoming call state due to the incoming call detected at step S21 or a telephone conversation state due to the incoming call has ended and transitioned to a standby state (step S23). The transfer control unit 2D performs the determination of step S23 by determining whether the telephone communication state notified by the HFP from the mobile phone 10 indicates a transition from an outgoing call state or a telephone conversation state to the standby state.

When it is determined that transition to the standby state has been made (Yes at step S23), the present routine proceeds to step S24.

At step S24, the transfer control unit 2D causes the transfer of the telephone data to be restarted from the beginning (step S24), and accepts the transfer of the telephone data from the mobile phone 10 again (step S25).

With this, the following effects are obtained even when the mobile phone 10 receives an incoming call during the transfer of the telephone data. That is, the transfer control unit 2D restarts the transfer process of the telephone data from the beginning after the incoming call state or the telephone conversation state due to the incoming call ends and transitions to the standby state. Therefore, it is possible to appropriately achieve the outgoing call history data, the incoming call history data, the missed call history data, and the phonebook data from the mobile phone 10. Therefore, it is possible to maintain consistency between these telephone data and telephone data stored in the mobile phone 10.

Next, the simultaneous connection process after the PBAP-based data transfer is succeeded will be described.

In the hands-free apparatus 1, the simultaneous connection state of the HFP and the PBAP is maintained even after the PBAP-based data transfer ends. Therefore, the hands-free apparatus 1 can start data transfer by the PBAP at a predetermined timing. Therefore, even when a new incoming call or outgoing call occurs in the mobile phone 10, the hands-free apparatus 1 side can update the latest telephone data of the mobile phone 10.

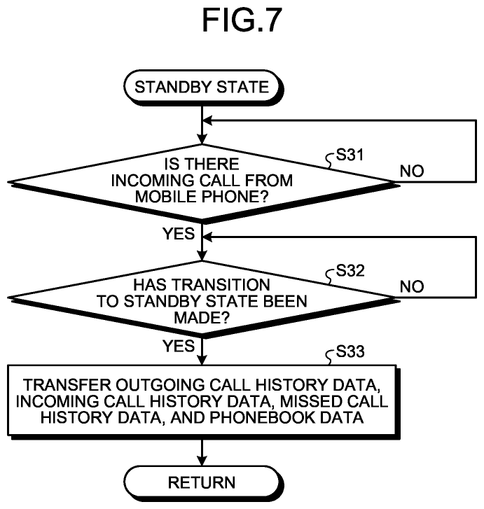

This will be described with reference to FIG. 7 to FIG. 12.

In FIG. 7 to FIG. 12, it is assumed for description that after the HFP connection at step S2 of FIG. 4, there is an incoming call or an outgoing call in the mobile phone 10 and incoming call history data and outgoing call history data including history of the incoming call and history of the outgoing call are stored in the mobile phone 10. Furthermore, it is assumed that after the HFP connection at step S2 of FIG. 4, outgoing call processing is performed by the mobile phone 10 via the Bluetooth communication unit 3 in accordance with an operation of the operating unit 4. In such a case, a telephone number of an outgoing call destination is sent from the hands-free apparatus 1 to the mobile phone 10 via the Bluetooth communication unit 3. Therefore, outgoing call history data including the transmission is also stored in the mobile phone 10.

FIG. 7 is a flowchart illustrating the flow of a transfer process performed in the hands-free apparatus 1 when outgoing call processing is performed in the mobile phone 10 by an operation of an operating unit of the mobile phone 10.

As described above, in the state in which the HFP connection has been established between the hands-free apparatus 1 and the mobile phone 10, it is possible to perform outgoing call processing by the operation of the operating unit 4 of the hands-free apparatus 1. Furthermore, in the state in which the HFP connection has been established, it is also possible to perform a hands-free telephone conversation by performing the outgoing call processing by the operation of the operating unit of the mobile phone 10.

In such a case, the hands-free apparatus 1 needs to acquire outgoing call history data by the outgoing call processing from the mobile phone 10 and to update the history data to the latest state. The hands-free apparatus 1 can determine whether there is an outgoing call from the hands-free apparatus 1. Furthermore, the hands-free apparatus 1 can also analyze a telephone communication state notified from the mobile phone 10 and determine whether there is an outgoing call from the mobile phone 10.

In this regard, the transfer control unit 2D determines whether there is an outgoing call from the mobile phone 10 while in a standby state (Yes at step S31). The transfer control unit 2D performs the determination of step S31 by determining whether a telephone communication state notified from the mobile phone 10 indicates an outgoing call state.

When a positive determination is made at step S31 (Yes at step S31), the present routine proceeds to step S32. At step S32, the transfer control unit 2D determines whether the outgoing call state determined at step S31 has transitioned to the standby state (step S32). The transfer control unit 2D performs the determination of step S32 by determining whether the telephone communication state notified by the HFP from the mobile phone 10 indicates a transition from the outgoing call state or a telephone conversation state to the standby state.

When it is determined that transition to the standby state has been made (Yes at step S32), the present routine proceeds to step S33. The pattern, in which it is determined at step S43 that transition to the standby state has been made, includes the following case, for example. For example, this is a case where the mobile phone 10 has rejected an incoming call. Furthermore, for example, this is a case where a mobile phone 10 of an outgoing call counterpart side has cancelled an outgoing call. Furthermore, this is a case where a telephone conversation has ended between a mobile phone 10 and a mobile phone 10.

At step S33, the transfer control unit 2D acquires the telephone data (the outgoing call history data, the incoming call history data, the missed call history data, and the phonebook data) from the mobile phone 10 (step S33).

With this, whenever an outgoing call from the mobile phone 10 ends, it is possible to acquire the outgoing call history data, the incoming call history data, the missed call history data, and the phonebook data from the mobile phone 10. Therefore, it is possible to maintain consistency between these telephone data and telephone data stored in the mobile phone 10.

Furthermore, at step S32 of FIG. 7, a transition to the standby state has been determined; however, a transition to an outgoing call state may also be determined.

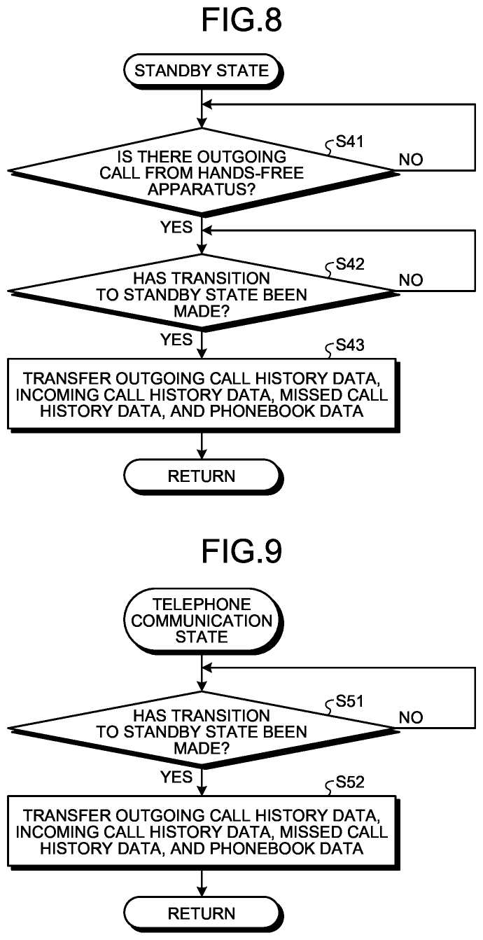

FIG. 8 is a flowchart illustrating the flow of a transfer process performed in the hands-free apparatus 1 when outgoing call processing is performed by an operation of the operating unit 4 of the hands-free apparatus 1.

The transfer control unit 2D determines whether there is an outgoing call from the hands-free apparatus 1 while in a standby state (Yes at step S41).

When a positive determination is made at step S41 (Yes at step S41), the present routine proceeds to step S42. At step S42, the transfer control unit 2D determines whether the outgoing call state determined at step S41 has been transitioned to a standby state (step S42). The transfer control unit 2D performs the determination of step S42 by determining whether the telephone communication state notified by the HFP from the mobile phone 10 indicates a transition from the outgoing call state or a telephone conversation state to the standby state.

When it is determined that transition to the standby state has been made (Yes at step S42), the present routine proceeds to step S43. The pattern, in which it is determined at step S43 that transition to the standby state has been made, includes the following case, for example. For example, this is a case where the hands-free apparatus 1 has cancelled an outgoing call therefrom. Furthermore, for example, this is a case where the mobile phone 10 has cancelled an outgoing call from the hands-free apparatus 1 or when a mobile phone 10 of an outgoing call counterpart side has rejected an incoming call.

At step S43, the transfer control unit 2D acquires the telephone data (the outgoing call history data, the incoming call history data, the missed call history data, and the phonebook data) from the mobile phone 10 (step S43).

With this, whenever an outgoing call from the hands-free apparatus 1 ends, it is possible to acquire the outgoing call history data, the incoming call history data, the missed call history data, and the phonebook data from the mobile phone 10. Therefore, it is possible to maintain consistency between these telephone data and telephone data stored in the mobile phone 10.

Furthermore, at step S42 of FIG. 8, a transition to the standby state has been determined; however, a transition to an outgoing call state may also be determined.

FIG. 9 is a modification of FIG. 7 and FIG. 8. FIG. 9 is a flowchart illustrating the flow of a transfer process performed in the hands-free apparatus 1 when transition from the telephone conversation state to the standby state has been made in FIG. 7 and FIG. 8.

The transfer control unit 2D determines whether transition to the standby state has been made when the hands-free apparatus 1 and the mobile phone 10 are in a hands-free telephone conversation state or the mobile phone 10 alone is in a telephone conversation state (step S51). When a positive determination is made at step S51, it means that the hands-free apparatus 1 has ended a conversation, the mobile phone 10 has ended a conversation, or a telephone conversation counterpart side has ended a conversation.

When the positive determination is made at step S51 (Yes at step S51), the present routing proceeds to step S52. At step S52, the transfer control unit 2D acquires the telephone data (the outgoing call history data, the incoming call history data, the missed call history data, and the phonebook data) from the mobile phone 10 (step S43).

Therefore, whenever a telephone conversation ends, it is possible to acquire the telephone data from the mobile phone 10. Therefore, it is possible to maintain consistency between telephone data stored in the hands-free apparatus 1 and telephone data stored in the mobile phone 10.

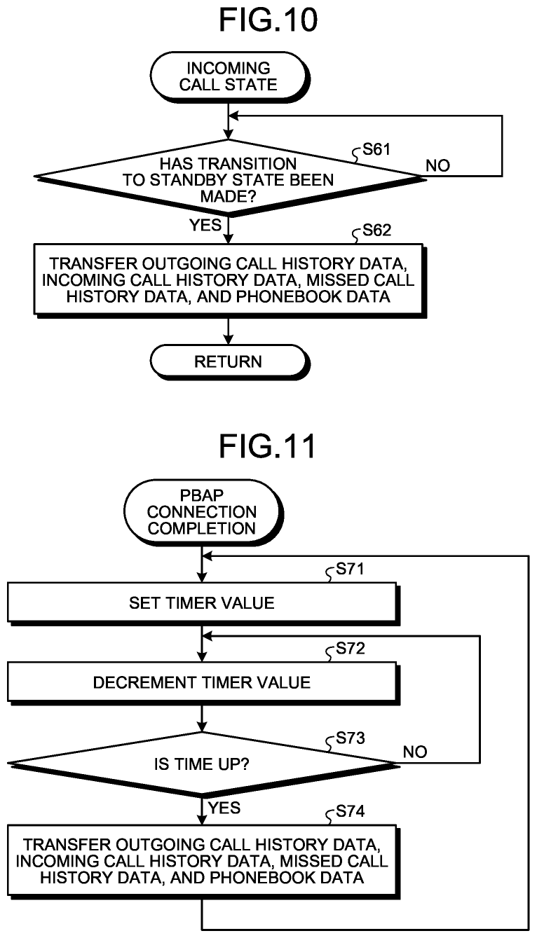

FIG. 10 is a modification of FIG. 7 and FIG. 8. FIG. 10 is a flowchart illustrating the flow of a transfer process performed in the hands-free apparatus 1 when transition from the incoming call state to the standby state has been made in FIG. 7 and FIG. 8.

The transfer control unit 2D determines whether transition to the standby state has been made when being in the incoming call state (step S61). A case where a positive determination is made at step S61 includes a case where transition to the standby state has been made due to incoming call rejection by the hands-free apparatus 1, incoming call rejection by the mobile phone 10, outgoing call cancellation by an outgoing call counterpart side, a transition to a telephone conversation state after receiving an incoming call and termination of the telephone conversation, and the like.

When the positive determination is made at step S61 (Yes at step S61), the present routing proceeds to step S62. At step S62, the transfer control unit 2D acquires the telephone data (the outgoing call history data, the incoming call history data, the missed call history data, and the phonebook data) from the mobile phone 10 (step S62).

Therefore, whenever an incoming call ends, it is possible to acquire the outgoing call history data, the incoming call history data, the missed call history data, and the phonebook data from the mobile phone 10. Therefore, it is possible to maintain consistency between telephone data stored in the hands-free apparatus 1 and telephone data stored in the mobile phone 10.

Note that the hands-free apparatus 1 can also transmit data immediately after a transition from a standby state to an incoming call state. However, an incoming call includes a missed call that does not answer an incoming call and an answer incoming call that changes from an incoming call state to a telephone conversation state. However, a telephone communication state eventually transitions to a standby state. Therefore, in a transition to the standby state, the transfer control unit 2D may acquire data indicating whether the incoming call is the missed call or the answer incoming call, from the mobile phone 10. In such a case, the display control unit 2E can display, on the display unit 5, a display screen indicating whether the incoming call is the missed call or the answer incoming call.

Note that the transfer control unit 2D may also control the timing of data transfer by using a timer.

FIG. 11 is a flowchart illustrating an example of the flow of data transfer timing control using a timer value.

When the data transfer connection processing unit 2B establishes a PBAP connection, the transfer control unit 2D sets a timer value (step S71). The transfer control unit 2D decrements the set timer value at predetermined time intervals (step S72). When the transfer control unit 2D determines that the time is up according to the timer value (Yes at step S73), the present routine proceeds to step S74.

At step S74, the transfer control unit 2D acquires the outgoing call history data, the incoming call history data, the missed call history data, and the phonebook data from the mobile phone 10 (step S74).

By the process illustrated in FIG. 11, the hands-free apparatus 1 can periodically acquire the outgoing call history data, the incoming call history data, the missed call history data, and the phonebook data from the mobile phone 10. Therefore, the hands-free apparatus 1 can maintain consistency between the telephone data of the mobile phone 10 and the telephone data of the hands-free apparatus 1.

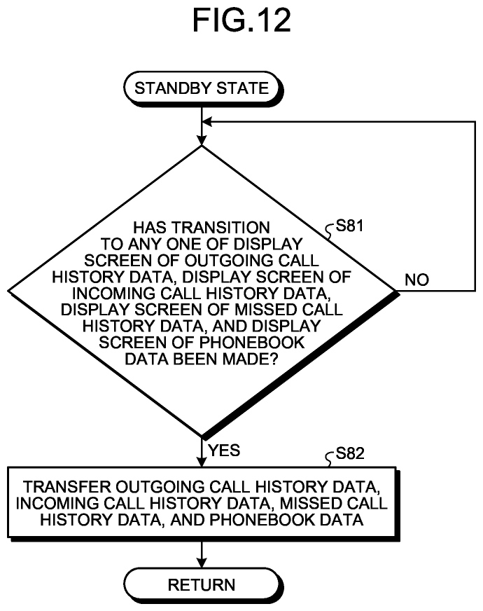

FIG. 12 is a flowchart illustrating the flow when data transfer is started with an operation of the operating unit 4 by the user as a trigger.

When a change instruction of a display screen is received by the operation of the operating unit 4 by the user, the display control unit 2E switches the display screen instructed to be changed to the history data or the phonebook data. Specifically, the display control unit 2E determines whether the display screen has been made to transition to any one of the outgoing call history data, the incoming call history data, the missed call history data, and the phonebook data (step S81).

When a positive determination is made at step S81 (Yes at step S81), the transfer control unit 2D causes the telephone data to be transferred from the mobile phone 10 (step S82).

In such a case, whenever the telephone data displayed on the display unit 5 is switched, the telephone data is automatically transferred from the mobile phone 10 to the hands-free apparatus 1.

Note that in the processes illustrated in FIG. 7 to FIG. 12, the mode in which the hands-free apparatus 1 periodically acquires the telephone data from the mobile phone 10 has been described. However, it takes time to convert the phonebook data included in the telephone data into a Vcard format. Furthermore, the amount of the phonebook data is larger than that of the history data. Therefore, load on the mobile phone 10 and the hands-free apparatus 1 is large, which may cause a reduction of the battery capacity of the mobile phone 10 and the hands-free apparatus 1.

In this regard, when the PBAP connection is established between the mobile phone 10 and the hands-free apparatus 1, the hands-free apparatus 1 may acquire the history data, which is the telephone data other than the phonebook data, from the mobile phone 10 for each predetermined timing. With this, it is possible to reduce the processing of the mobile phone 10 and the hands-free apparatus 1, and to suppress a decrease in the battery capacity thereof.

Furthermore, the transfer control unit 2D of the hands-free apparatus 1 may perform transfer control such that only the incoming call history data and the missed call history data are transferred when there is an incoming call, and perform transfer control such that only the outgoing call history data is transferred when there is an outgoing call. As a consequence, it is possible to omit wasteful data transfer, to reduce the processing of the mobile phone 10, and to suppress a decrease in the battery capacity thereof.

Note that in the processes described with reference to FIG. 7 to FIG. 12 may also be performed individually or in combination with each other.

The process performed by the hands-free apparatus 1 with respect to the data transferred from the mobile phone 10 to the hands-free apparatus 1 will be described.

Note that in the following, it is assumed for description that the number of data included in history data storable in the working memory 6 of the hands-free apparatus 1 is smaller than that of data included in the history data automatically transferred from the mobile phone 10. Specifically, it is assumed for description that the number of data included in each of the outgoing call history data, the incoming call history data, and the missed call history data automatically transferred from the mobile phone 10 is 20. Furthermore, it is assumed for description that the number of data included in each of these history data, which is storable in the working memory 6, is 5.

The display control unit 2E of the control unit 2 discards outgoing call history data with an old outgoing call date and time among the outgoing call history data automatically transferred from the mobile phone 10. Then, the display control unit 2E stores 5 pieces of outgoing call history data with a new outgoing call date and time in the working memory 6. Similarly, the display control unit 2E stores, in the working memory 6, 5 pieces of history data with a new outgoing call date and time among the other history data (the incoming call history data and the missed call history data).

Then, it is sufficient if the display control unit 2E displays the stored history data and phonebook data on the display unit 5 in accordance with an operation instruction and the like of the operating unit 4 by the user.

Note that the incoming call history data is history data that has answered an incoming call and the missed call history data is history data that has not answered an incoming call.

Therefore, when displaying a list of these history data at the same time, the display control unit 2E preferably displays, for each corresponding history data, at least one of an icon figure representing an answered incoming call and an icon figure representing a missed call that is an unanswered incoming call. A figure composed of a combination of a handset and an arrow, for example, may be used as the icon figure representing an answered incoming call. Furthermore, a figure composed of a combination of a handset and a mark x, for example, may be used as the icon figure representing a missed call.

Furthermore, the data transfer connection processing unit 2B may designate the number (five in the present embodiment) of data to be automatically transferred by the hands-free apparatus 1 to the mobile phone 10 when connecting the PBAP, and preferentially store, in the working memory 6, outgoing call history data, incoming call history data, and missed call history data with a new outgoing call date and time or incoming call date and time.

The mobile phone 10 needs to convert the data format of the phonebook data into the data format of “Vcard” defined in the Bluetooth communication standard, and to transfer the converted data to the hands-free apparatus 1. In general, the phonebook data is updated less frequently than history data such as the outgoing call history data and the incoming call history data.

Therefore, the transfer control unit 2D may control the phonebook data to be transferred after the history data, such as the outgoing call history data, the incoming call history data, and the missed call history data, is transferred from the mobile phone 10. Furthermore, when a predetermined operation instruction is accepted by the operation of the operating unit 4 by the user after the history data is transferred from the mobile phone 10, the transfer control unit 2D may control the phonebook data to be transferred.

In such a case, the history data with high data update frequency is transferred to the hands-free apparatus 1 in preference to the phonebook data with low data update frequency. Furthermore, the history data requiring no data conversion for transfer can be transferred from the mobile phone 10 to the hands-free apparatus 1 in preference to the phonebook data requiring data conversion for transfer. Therefore, in the hands-free apparatus 1 of the present embodiment, it is possible to improve convenience. Furthermore, whether to transfer the phonebook data can also be selected by the operation of the operating unit 4 by the user.

Furthermore, in the above description, the mode in which the outgoing call history data, the incoming call history data, the missed call history data, and the phonebook data are automatically transferred has been described; however, some of them may also be manually transferred. In such a case, it is sufficient if the hands-free apparatus 1 accepts the selection of manual transfer and automatic transfer from the user and sets either the manual transfer or the automatic transfer in advance. Then, the hands-free apparatus 1 may perform the PBAP process in accordance with the setting. For example, when the user does not set the automatic transfer, only the outgoing call history data, the incoming call history data, and the missed call history data are automatically transferred. On the other hand, when the phonebook data is transferred by the manual setting, only the phonebook data is stored in the storage memory 7 with non-volatility. Then, the stored data may be read from the storage memory 7 and used as phonebook data at the next activation of the hands-free apparatus 1.

Furthermore, the control unit 2 of the hands-free apparatus 1 may store, in the working memory 6, the outgoing call history data, the incoming call history data, and the phonebook data transferred from the mobile phone 10 in a distinguished manner for each mobile phone 10 as a transfer source. In such a case, the control unit 2 generates a link key based on IDs of mobile phones 10 as transfer sources and an ID of the hands-free apparatus 1. Then, it is sufficient if the control unit 2 correlates the link key and telephone data transferred from a mobile phone 10 identified by the ID used for generating the link key and stores the correlated data in the working memory 6. Whenever telephone data is transferred from a mobile phone 10, the control unit 2 generates a link key by using an ID of the mobile phone 10. Then, it is sufficient if the control unit 2 updates the transferred telephone data by storing the telephone data in the working memory 6 in correlation with the generated link key.

By storing the telephone data in a distinguished manner for each mobile phone 10 as a transfer source, the hands-free apparatus 1 can manage the telephone data for each mobile phone 10. Furthermore, in such a case, whenever the supply of power to the hands-free apparatus 1 is started, it is not necessary to receive phonebook data from the mobile phone 10. Therefore, the user can quickly use phonebook data corresponding to his/her mobile phone 10 with the hands-free apparatus 1. Furthermore, it is possible to significantly improve convenience when using a phonebook function.

Note that in the present embodiment, the mode in which the telephone data transferred from the mobile phone 10 is stored in the working memory 6 has been described as an example. However, at least one type of telephone data may also be stored in the storage memory 7. For example, the history data may also be stored in the working memory 6 and the phonebook data may also be stored in the storage memory 7. Furthermore, both the history data and the phonebook data may also be stored in the storage memory 7.

Next, the software update process by the update unit 2C and the transfer control by the transfer control unit 2D during software update will be described in detail.

When the software update process by the update unit 2C occurs, the transfer control unit 2D performs the transfer control for disabling the transfer of telephone data during the software update process.

Specifically, the transfer control unit 2D performs the transfer control for controlling the data transfer connection processing unit 2B to disable the transfer of the telephone data during the software update process by the update unit 2C.

When the update unit 2C determines to update the software, the transfer control unit 2D performs the transfer control for disabling the transfer of the telephone data. The transfer control unit 2D performs the transfer control by controlling the data transfer connection processing unit 2B to transmit the transfer stop request to a mobile phone 10. The mobile phone 10 having accepted the transfer stop request stops or interrupts the transfer of telephone data being transferred and does not also transfer other telephone data. Therefore, the transfer of the telephone data from the mobile phone 10 to the hands-free apparatus 1 is stopped or interrupted.

When the transfer of the telephone data is disabled, the update unit 2C performs the software update process. Therefore, the update unit 2C can perform the software update process in the state in which the transfer of the telephone data using the PBAP has been stopped or interrupted.

There is a case where the PBAP connection is in progress at the stage after the software update process. For example, there is a case where the PBAP connection established before the software update process is continued even after the software update process. For example, there is a case where the PBAP connection with a mobile phone 10, for which the PBAP connection has been established before the software update process, is maintained even during the update process. Furthermore, for example, there is a case where setting on a mobile phone 10 side is changed during the software update process, so that the PBAP connection is possible and a connection using the PBAP is established. Furthermore, there is a case where during the software update process, a mobile phone 10, to which the PBAP can be connected, enters the wireless communication range of the hands-free apparatus 1, so that the connection using the PBAP is established.

In such a case, after the software update process by the update unit 2C is completed, the transfer control unit 2D performs the transfer control for causing the telephone data to be transferred.

Specifically, the transfer control unit 2D performs the transfer control for accepting the transfer of the telephone data by controlling the data transfer connection processing unit 2B to transmit the transfer request to a mobile phone 10.

For example, the transfer control unit 2D controls the data transfer connection processing unit 2B to transmit a transfer request corresponding to telephone data whose transfer has been interrupted by the software update process. That is, the transfer control unit 2D controls the data transfer connection processing unit 2B such that the telephone data whose transfer has been interrupted is retransferred. Therefore, the telephone data whose transfer has been interrupted is retransferred from the mobile phone 10 to the hands-free apparatus 1.

Furthermore, in such a case, the transfer control unit 2D may control the data transfer connection processing unit 2B such that all types of telephone data such as the incoming call history data, the missed call history data, and the outgoing call history data, are retransferred. Furthermore, the transfer control unit 2D may perform the transfer control such that the telephone data whose transfer has been interrupted, for example, only the incoming call history data, is retransferred.

On the other hand, there is a case where the PBAP connection established before the software update process is disconnected by the software update process.

Furthermore, there is a case where a new mobile phone 10 enters a state in which the PBAP can be connected, after the software update process. For example, there is a case where a new mobile phone 10 enters the wireless communication range of the hands-free apparatus 1 after the software update process. Furthermore, for example, there is a case where the PBAP connection function of the hands-free apparatus 1 is turned off before the software update process, and the PBAP connection function is turned on by the software update process. For example, there is a case where such a change occurs by changing or initializing a setting value. Furthermore, there is a case where the connection using the PBAP is possible by solving problems of the function of the hands-free apparatus 1 related to the PBAP connection or adding a function through software update.

In such a case, after the software update process by the update unit 2C is completed, the data transfer connection processing unit 2B performs a connection process of establishing the connection using the PBAP with a mobile phone 10. That is, the data transfer connection processing unit 2B selects a mobile phone 10 within a wireless communication service area as a target of connection of the HFP, and establishes the PBAP connection to the mobile phone 10. The data transfer connection processing unit 2B establishes the PBAP connection by performing an initial connection process which is a connection process for establishing a communication link used for data transfer using the PBAP.

Note that there is a case where the connection using the HFP is disconnected by the software update process. In such a case, it is sufficient if the hands-free connection unit 2A establishes the connection using the HFP with a mobile phone 10 before the PBAP connection is established by the data transfer connection processing unit 2B.

Then, it is sufficient if the transfer control unit 2D performs the transfer control for causing the telephone data to be transferred from the mobile phone 10 for which the PBAP connection has been established.

Note that there is a case where the software update process occurs during the initial connection process by the data transfer connection processing unit 2B. The initial connection process is a connection process for establishing a communication link used for data transfer using the PBAP. Even in such a case, it is sufficient if the transfer control unit 2D performs the transfer control for disabling the transfer of the telephone data during the software update process.

Furthermore, the control unit 2 may perform the following processing when software update preparation by the update unit 2C has been completed.

Specifically, it is assumed that the telephone data is being transferred when the software update preparation has been completed. In such a case, it is sufficient if the transfer control unit 2D controls the update unit 2C to perform the software update process after the transfer of the telephone data being transferred is completed.

Furthermore, when the software update preparation has been completed, the display control unit 2E may display a display screen for accepting the input of an update execution instruction on the display unit 5. The time when the software update preparation has been completed is the timing before the update unit 2C acquires software to be updated and performs the software update process. The user inputs the update execution instruction by operating the operating unit 4.

Then, when the software update preparation has been completed, if the update execution instruction is accepted from the user, it is sufficient if the transfer control unit 2D causes the update unit 2C to perform the software update process after performing the transfer control for disabling the transfer of the telephone data.

Furthermore, when the display screen for accepting the input of the update execution instruction is displayed, the user may perform the following operations. For example, the user may input the update execution instruction after the transfer of the telephone data is completed, by operating the operating unit 4. When the software update preparation has been completed, if the update execution instruction after the completion of the transfer is accepted, it is sufficient if the transfer control unit 2D causes the update unit 2C to perform the software update process after the transfer of the telephone data is completed.

Next, the flow of the transfer control during the software update process will be described.

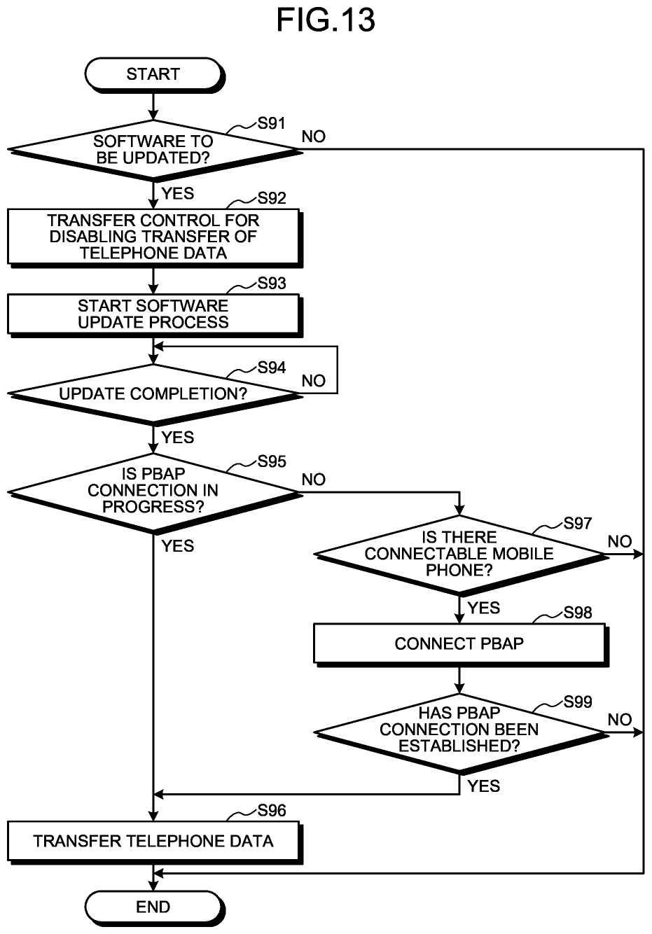

FIG. 13 is a flowchart illustrating an example of the flow of the transfer control during the software update process.

The update unit 2C determines whether to update the software of the hands-free apparatus 1 (step S91). When a negative determination is made at step S91 (No at step S91), the present routine ends. When it is determined to update the software of the hands-free apparatus 1 (Yes at step S91), the present routine proceeds to step S92.

At step S92, the transfer control unit 2D performs the transfer control for disabling the transfer of the telephone data (step S92). By the process of step S92, the transfer of the telephone data using the PBAP from the mobile phone 10 to the hands-free apparatus 1 is stopped or interrupted.

Next, the update unit 2C starts the software update process (step S93). The update unit 2C repeats a negative determination (No at step S94) until it is determined that the update of the software has been completed (Yes at step S94). When it is determined that the update of the software has been completed (Yes at step S94), the present routine proceeds to step S95.

At step S95, the transfer control unit 2D determines whether the PBAP connection is in progress (step S95). The “PBAP connection is in progress” means that the PBAP connection has been established. When the PBAP connection is in progress (Yes at step S95), the present routine proceeds to step S96.

At step S96, the transfer control unit 2D performs the transfer control for causing the telephone data to be transferred. Therefore, when software update occurs, the transfer of the telephone data is disabled, and after the software update is completed, the transfer of the telephone data is restarted.

On the other hand, when a negative determination is made at step 95 (No at step S95), the present routine proceeds to step S97. At step S97, the data transfer connection processing unit 2B determines whether there is a mobile phone 10 to which the PBAP can be connected (step S97). When a negative determination is made at step S97 (No at step S97), the present routine ends.

When there is a mobile phone 10 to which the PBAP can be connected (Yes at step S97), the data transfer connection processing unit 2B connects the PBAP to the mobile phone 10 determined at step S97 (step S98).

The data transfer connection processing unit 2B determines whether the PBAP connection has been established (step S99). When a positive determination is made (Yes at step S99), the present routine proceeds to step S96. When a negative determination is made (No at step S99), the present routine ends.

Therefore, when the software update occurs, the transfer of the telephone data is disabled, and after the software update is completed, it is possible to accept the transfer of the telephone data from the mobile phone 10 for which the PBAP connection has been established.

As described above, the hands-free apparatus 1 of the present embodiment includes the hands-free connection unit 2A, the data transfer connection processing unit 2B, the update unit 2C, and the transfer control unit 2D. The hands-free connection unit 2A performs the hands-free connection process of connecting to the mobile phone 10 by using the hands-free communication protocol (HFP) for performing a hands-free telephone conversation. The data transfer connection processing unit 2B performs the connection process with the mobile phone 10 by using the data transfer protocol (PBAP) for transferring the telephone data related to telephone, and the data transfer process of causing the telephone data to be transferred from the mobile phone 10. The update unit 2C performs the software update process of the hands-free apparatus 1. The transfer control unit 2D performs the transfer control for disabling the transfer of the telephone data during the software update process.

As described above, in the hands-free apparatus 1 of the present embodiment, the transfer control unit 2D performs the transfer control for disabling the transfer of the telephone data during the software update process.

Therefore, it is possible to suppress occurrence of problems related to communication using a data transfer protocol such as the PBAP due to a transfer error of the telephone data, a connection disconnection, and the like resulting from software update.

Accordingly, the hands-free apparatus 1 of the present embodiment can implement good communication using the data transfer protocol even during the software update.

Furthermore, according to the hands-free apparatus 1 of the present embodiment, the simultaneous connection between the HFP and the PBAP is performed, and PBAP-based data transfer is performed only when necessary. Therefore, in the hands-free apparatus 1 of the present embodiment, it is possible to update the history data of the hands-free apparatus 1 in accordance with the latest history data in the mobile phone 10 without unnecessary data transfer.

Furthermore, the hands-free apparatus 1 establishes a Bluetooth communication line with the mobile phone 10 and stores the telephone data automatically transferred from the mobile phone 10 in the working memory 6. Therefore, the hands-free apparatus 1 can enable an outgoing call operation by the outgoing call history data and the incoming call history data stored in the working memory 6. Thus, the hands-free apparatus 1 can select a desired telephone number from the history data automatically transferred from the mobile phone 10 and make an outgoing call. Furthermore, the hands-free apparatus 1 can also select a desired telephone number from the outgoing call history data and the incoming call history data of the apparatus and make an outgoing call. Therefore, the hands-free apparatus 1 of the present embodiment can improve convenience in addition to the aforementioned effects.

Note that in the present embodiment, the transfer control unit 2D performs the transfer control for disabling the transfer of the telephone data during the software update process; however, the transfer control unit 2D may not perform the above control. For example, in the present embodiment, the control content of each process described as disabling the transfer of the telephone data by the transfer control unit 2D does not represent that the transfer control unit 2D does not actively stop or interrupt the transfer of the telephone data, and may represent that the transfer control unit 2D does not simply perform the transfer of the telephone data. For example, the transfer control unit 2D may be configured not to perform the transfer of the telephone data as a result of termination and the like of an application program during the software update process.

A computer program executed by the hands-free apparatus 1 of the aforementioned each embodiment is provided by being incorporated in a ROM and the like in advance. The computer program executed by the hands-free apparatus 1 of the aforementioned each embodiment may be configured to be provided by being recorded on a computer-readable recording medium, such as a CD-ROM, a flexible disk (FD), a CD-R, or a digital versatile disc (DVD), in an installable or executable file.

Moreover, the computer program executed by the hands-free apparatus 1 of the aforementioned each embodiment may be configured to be stored on a computer connected to a network such as the Internet and to be provided by being downloaded via the network. Furthermore, the computer program executed by the hands-free apparatus 1 of the aforementioned each embodiment may be configured to be provided or distributed via the network such as the Internet.

### OTHER EMBODIMENTS

Although the embodiments have been described above, these embodiments have been presented by way of example only and are not intended to limit the scope of the present disclosure. The aforementioned novel embodiments can be implemented in various other forms, and various omissions, substitutions, and changes in the form of the embodiments described herein may be made without departing from the spirit of the inventions. The aforementioned embodiments are included in the scope or spirit of the present disclosure and are included in the accompanying claims and the equivalents thereof.

For example, the present invention is not limited to the aforementioned each embodiment and can be modified or extended as follows.

The hands-free apparatus 1 may be composed of a hands-free dedicated apparatus that mainly implements a hands-free function or may be an apparatus in which a hands-free function is installed in a vehicle audio apparatus for reproducing CDs or radio. Furthermore, the hands-free apparatus 1 may have a portable (portable type) configuration.

The present disclosure is not limited to the configuration in which the mobile phone 10 and the hands-free apparatus 1 perform Bluetooth communication, and may have a configuration of performing other near-field wireless communication or a configuration of performing wired communication.

The hands-free apparatus 1 may be configured to store the outgoing call history data, the incoming call history data, and the phonebook data received from the mobile phone 10 in the storage memory 7, and to update and store the outgoing call history data, the incoming call history data, and the phonebook data whenever outgoing call history data, incoming call history data, and phonebook data are received from the mobile phone 10. Furthermore, the hands-free apparatus 1 may be configured to store the outgoing call history data, the incoming call history data, and the phonebook data received from the mobile phone 10 in both the working memory 6 and the storage memory 7 and to use the storage memory 7 as a backup memory.

The number of the outgoing call history data or the incoming call history data that can be stored in the working memory 6 may be one. In such a case, when the hands-free apparatus 1 performs the outgoing call processing or the incoming call processing, the outgoing call history data or the incoming call history data received by the PBAP-based wireless communication connection is necessarily deleted.

Furthermore, the hands-free apparatus 1 simultaneously displays a plurality of outgoing call history data and a plurality of incoming call history data; however, they may be displayed one by one. In such a case, for example, the latest data may be displayed first, and then the second latest data may be displayed in order by an operation of the operating unit 14.

The number of the outgoing call history data or the incoming call history data that can be stored in the working memory 6 may be one. In such a case, when the hands-free apparatus 1 performs the outgoing call processing or the incoming call processing, the outgoing call history data or the incoming call history data received by the PBAP-based wireless communication connection is necessarily deleted.

The present disclosure is not limited to the configuration in which when the mobile phone 10 and the hands-free apparatus 1 establish a Bluetooth communication line, the outgoing call history data and the incoming call history data are automatically transferred, and may have a configuration in which the outgoing call history data, the incoming call history data, and the phonebook data are transferred on condition that the user operates the hands-free apparatus 1 or the mobile phone 10.

When the outgoing call history data, the incoming call history data, and the phonebook data received from the mobile phone 10 are distinguished for each mobile phone 10 and are stored in the working memory 6, the mobile phone 10 and the data stored in the working memory 6 may be correlated with each other by a method of generating the link key or by other methods.

Note that the computer program for executing the aforementioned processing in the aforementioned embodiments has a module configuration including each of the aforementioned functional units. As actual hardware, for example, a CPU (processor circuit) reads and executes an information processing program from a ROM or a HDD, so that each of the aforementioned functional units is loaded into a RAM (main memory) and is generated on the RAM (main memory). Note that a part or all of each of the aforementioned functional units can also be implemented using dedicated hardware such as an application specific integrated circuit (ASIC) and a field-programmable gate array (FPGA).

In accordance with a hands-free apparatus, a data transfer method, and a computer-readable medium according to the present disclosure, it is possible to implement good communication using a data transfer protocol even during software update.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A hands-free apparatus comprising:
a memory; and
a hardware processor coupled to the memory, the hardware processor being configured to:
perform a hands-free connection process of connecting to a mobile phone by using a hands-free communication protocol for performing a hands-free telephone conversation;
perform a connection process with a mobile phone by using a data transfer protocol for transferring telephone data related to telephone, and a data transfer process of causing the telephone data to be transferred from the mobile phone;
perform a software update process of the hands-free apparatus; and
perform transfer control for causing the telephone data to be transferred, wherein
the hardware processor is configured to cause transfer of the telephone data not to be performed during the software update process.

2. The hands-free apparatus according to claim 1, wherein the hardware processor is configured to perform the connection process of establishing a connection with the mobile phone by using the data transfer protocol, after the software update process is completed.

3. The hands-free apparatus according to claim 1, wherein the hardware processor is configured to perform the transfer control for causing the telephone data to be transferred, after the software update process is completed.

4. The hands-free apparatus according to claim 1, wherein the hardware processor is configured not to perform the transfer of the telephone data during the software update process, when the software update process occurs during the connection process.

5. The hands-free apparatus according to claim 1, wherein the hardware processor is configured to cause the software update process to be performed after transfer of the telephone data is completed, in a case where the telephone data is being transferred when preparation for the software update is completed.

6. The hands-free apparatus according to claim 1, wherein the hardware processor is configured to cause the software update process to be performed, in a case where an update execution instruction by a user is accepted when preparation for software update by the hardware processor is completed.

7. The hands-free apparatus according to claim 1, wherein the hardware processor is configured to cause the software update process to be performed after the transfer of the telephone data is completed, in a case where an instruction by a user to execute update after completion of the transfer is accepted when preparation for software update by the hardware processor is completed.

8. A data transfer method executed by a computer, the data transfer method comprising:
performing a hands-free connection process of connecting to a mobile phone by using a hands-free communication protocol for performing a hands-free telephone conversation;
performing a connection process with a mobile phone by using a data transfer protocol for transferring telephone data related to telephone, and a data transfer process of causing the telephone data to be transferred from the mobile phone; and
performing a software update process, wherein
during the software update process, transfer of the telephone data by the data transfer process is not performed.

9. A non-transitory computer readable medium on which an executable program is recorded, the program instructing a computer to carry out:
performing a hands-free connection process of connecting to a mobile phone by using a hands-free communication protocol for performing a hands-free telephone conversation;
performing a connection process with a mobile phone by using a data transfer protocol for transferring telephone data related to telephone, and a data transfer process of causing the telephone data to be transferred from the mobile phone; and
performing a software update process, wherein
during the software update process, transfer of the telephone data by the data transfer process is not performed.
